(19) United States
(12) Patent Application Publication
(10) Pub. No.: US 2026/0074097 A1
(43) Pub. Date: Mar. 12, 2026

(54) OVER-VOLTAGE PROTECTION DEVICE

(71) Applicant: Polytronics Technology Corp., HSINCHU (TW)

(72) Inventors: Hsuan Chen LIAO, Kaohsiung City (TW); Hsiu-Che YEN, Taoyuan City (TW); Cheng-Yu TUNG, Tainan City (TW); Yung-Hsien CHANG, Douliu City (TW); Chen-Nan LIU, Pitou Township (TW); Chingting CHIU, Taoyuan City (TW); Yao-Te CHANG, Yunlin County (TW)

(21) Appl. No.: 19/058,478

(22) Filed: Feb. 20, 2025

(30) Foreign Application Priority Data
Sep. 6, 2024 (TW) 113133859

(51) Int. Cl. H01C 7/12; H01C 1/14

(52) U.S. Cl. CPC H01C 7/12; H01C 1/14

(57) ABSTRACT

An over-voltage protection device includes a substrate, a voltage variable material, and an electrode set. A recess is formed on the surface of the substrate, and the voltage variable material is disposed in the recess. The voltage variable material includes an insulated metal material, a perovskite-based compound, and a silicone-containing resin. The perovskite-based compound is selected from the group consisting of calcium titanate, strontium titanate, barium titanate, and combinations thereof. The total volume of the voltage variable material is taken as 100%, and the perovskite-based compound accounts for 0.5% to 4.5%. The electrode set includes a first electrode and a second electrode respectively connected to two terminals of the voltage variable material.

### BACKGROUND OF THE INVENTION

### (1) Field of the Invention

The present application relates to an over-voltage protection device, and more specifically, to an over-voltage protection device with excellent voltage endurance and durability.

### (2) Description of the Related Art

Integrated circuits are externally fed with supply potentials and input signals to be processed and to have processed output signals received from them. In particular, the input signal terminals are very sensitive, since the conductor tracks that feed the potentials and signals lead directly to a gate terminal of an input switching stage. While the integrated circuit is being manually handled, or during the automated processing to solder the integrated circuit on a circuit board, there is risk that the sensitive input stage or output stage may be destroyed by electrostatic discharge (ESD). For example, the human body may be electrostatically charged and then discharged via the terminals leading to the outside of the semiconductor component containing the integrated circuit.

Tools of automatic component-mounting machines or test equipment may also be electrostatically charged and discharged via the semiconductor component. As technology advances and the scale of pattern lines on the semiconductor body bearing integrated circuits becomes smaller, there is a need for protection against such electrostatic discharges. Therefore, integrated circuit devices are often provided with protection devices against electrostatic discharge (i.e., ESD protection devices) and connected in their input paths.

In recent years, to provide more comprehensive protection, there is a need in the industry for ESD protection devices that can withstand higher voltages. For instance, U.S. Pat. No. 10,181,718 discloses an ESD protection device with an interior comprising a hollow space to accommodate a voltage variable material, thereby retaining the structural integrity of the voltage variable material and enhancing the voltage endurance of the ESD protection device. However, this design needs to reserve the space for accommodating the voltage variable material, leading to a larger size for the ESD protection device. This does not meet the current trend of device miniaturization.

When the device size is reduced by removing the hollow space or through other means, various defects in electrical characteristics are prone to exacerbation as the size of the ESD protection device decreases. If one intends to improve the physical and chemical properties of the voltage variable material itself, achieving significant breakthroughs is often challenging due to the amplification of defects caused by the size reduction.

Accordingly, there is a need to provide an ESD protection device with high voltage endurance and superior durability.

### SUMMARY OF THE INVENTION

In accordance with an aspect of the present invention, an over-voltage protection device includes a substrate, a voltage variable material, and an electrode set. The substrate has a surface and a recess formed on the surface. The voltage variable material is disposed in the recess, and includes an insulated metal material, a perovskite-based compound, and a silicone-containing resin. The perovskite-based compound is selected from the group consisting of calcium titanate, strontium titanate, barium titanate, and combinations thereof. The total volume of the voltage variable material is taken as 100%, and the perovskite-based compound accounts for 0.5% to 4.5%. An electrode set includes a first electrode and a second electrode respectively connected to two terminals of the voltage variable material.

In an embodiment, the perovskite-based compound is strontium titanate, accounting for 1% to 4% by volume.

In an embodiment, the total volume of the voltage variable material is taken as 100%, and the silicone-containing resin accounts for 51% to 55%.

In an embodiment, the silicone-containing resin is selected from the group consisting of silicone rubber, polydimethylsiloxane, polyethylpropylsiloxane, polypropylbutylsiloxane, polydiphenylsiloxane, polymethylphenylsiloxane, and combinations thereof.

In an embodiment, the total volume of the voltage variable material is taken as 100%, and the insulated metal material accounts for 42% to 46.5%. The insulated metal material consists of a plurality of core metal particles, and each core metal particle is enclosed by an insulating layer.

In an embodiment, the insulated metal material has a particle diameter ranging from 0.1 μm to 10 μm.

In an embodiment, the plurality of core metal particles include iron, gold, silver, copper, nickel, tin, platinum, zinc, metal carbide, or combinations thereof.

In an embodiment, the insulating layer includes iron oxide, zirconium dioxide, aluminum oxide, hafnium dioxide, titanium dioxide, manganese oxide, or silicon dioxide.

In an embodiment, the voltage variable material has a width parallel to the surface and a height perpendicular to the surface, wherein the width ranges from 36 μm to 48 μm, and the height ranges from 55 μm to 65 μm.

In an embodiment, the voltage variable material attaches to the surface and extends by a distance, whereby a width of the voltage variable material inside the recess is smaller than a width of the voltage variable material outside the recess.

In an embodiment, the first electrode has a first extending part and the second electrode has a second extending part. The first extending part is connected to the voltage variable material in a direction toward the second electrode along the surface of the substrate, and the second extending part is connected to the voltage variable material in a direction toward the first electrode along the surface of the substrate.

In an embodiment, the over-voltage protection device further includes a protection layer. The protection layer covers the first extending part, the voltage variable material, and the second extending part.

In an embodiment, the protection layer includes bisphenol A epoxy resin, bisphenol F epoxy resin, bisphenol S epoxy resin, or combinations thereof.

In an embodiment, the protection layer has a glass transition temperature higher than 140° C.

In an embodiment, the glass transition temperature of the protection layer ranges from 150° C. to 165° C.

In an embodiment, the protection layer has a coefficient of thermal expansion (CTE) al ranging from 25 ppm/° C. to 35 ppm/° C., and has a CTE α2 ranging from 135 ppm/° C. to 145 ppm/° C.

In an embodiment, a voltage-endurance value of the over-voltage protection device is at least 8 kV, whereby the over-voltage protection device is not burnt out after being subjected to 8 kV for 1000 cycles.

In an embodiment, a voltage-endurance value of the over-voltage protection device is at least 30 kV, whereby the over-voltage protection device is not burnt out after being subjected to 30 kV for 100 cycles.

In an embodiment, a leakage current of the over-voltage protection device is lower than 0.5 nA.

### BRIEF DESCRIPTION OF THE DRA WINGS

The present application will be described according to the appended drawings in which:

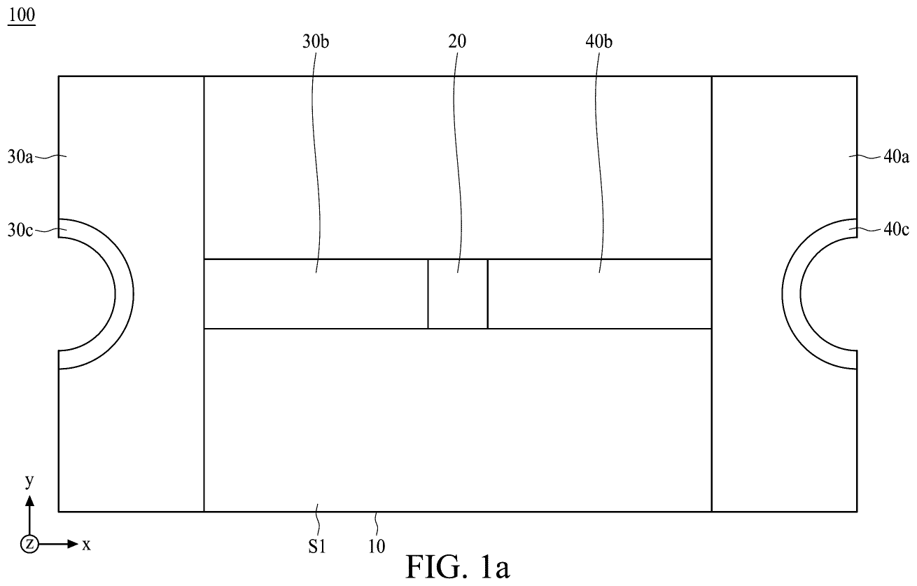

FIG. 1a and FIG. 1b show top views of an over-voltage protection device of the present invention;

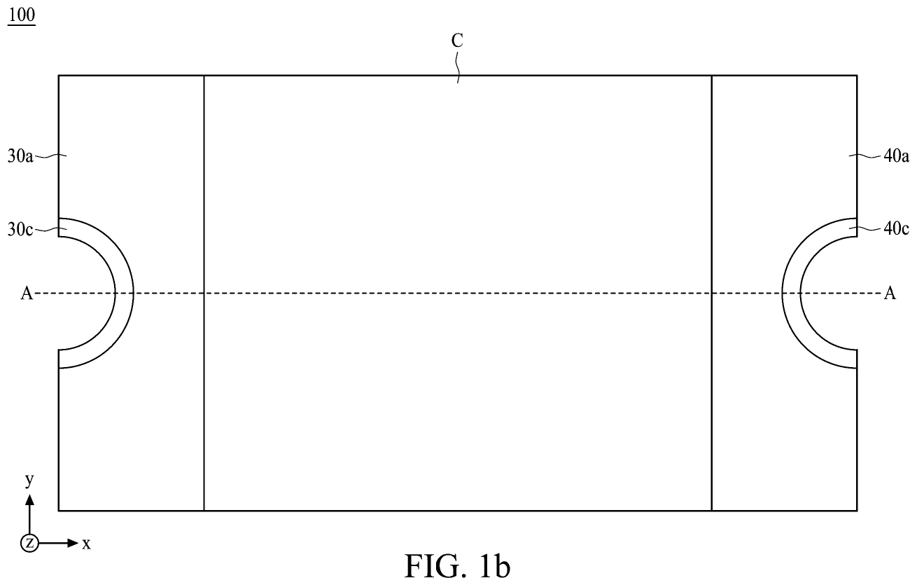

FIG. 2 shows a cross-sectional view of the over-voltage protection device along line AA depicted in FIG. 1b;

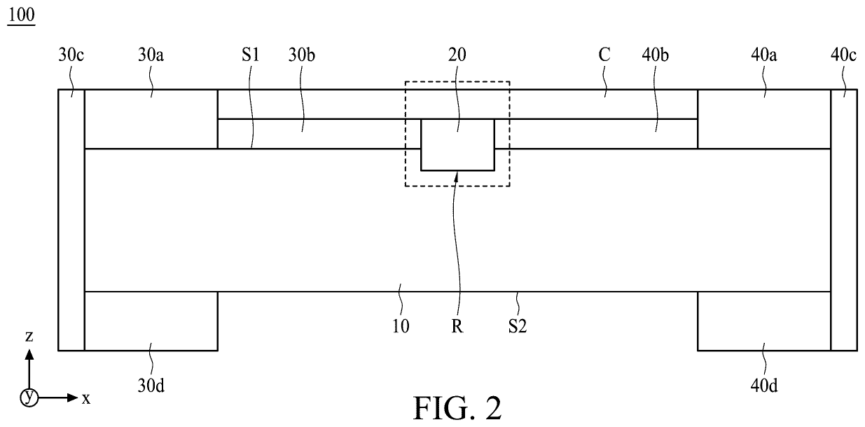

FIG. 3 shows an enlarged view of a part of the over-voltage protection device in FIG. 2; and

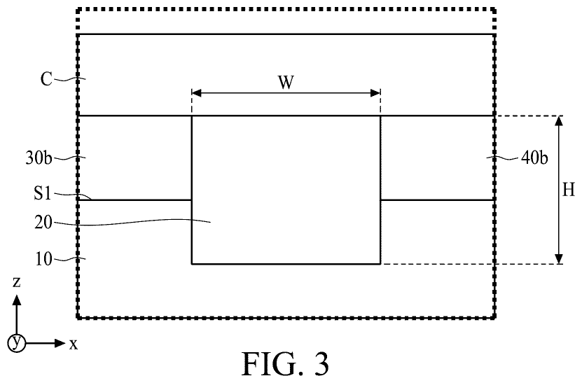

FIG. 4 shows an enlarged view of a part of the over-voltage protection device in FIG. 2 in accordance with one embodiment.

### DETAILED DESCRIPTION OF THE INVENTION

The making and using of the presently preferred illustrative embodiments are discussed in detail below. It should be appreciated, however, that the present application provides many applicable inventive concepts that can be embodied in a wide variety of specific contexts. The specific illustrative embodiments discussed are merely illustrative of specific ways to make and use the invention, and do not limit the scope of the invention.

Please refer to FIG. 1a and FIG. 1b, which show the top views of an over-voltage protection device 100 of the present invention. The difference between FIG. 1a and FIG. 1b is the presence of a protection layer C. To describe the configuration of the components beneath the protection layer C, the protection layer C is omitted in FIG. 1a. As shown in FIG. 1a, the over-voltage protection device 100 includes a substrate 10, a voltage variable material 20, and an electrode set. The substrate 10 has a top surface S1 and an recess R (shown in FIG. 2) formed on the top surface S1. The voltage variable material 20 is disposed in the recess R. The electrode set includes a first electrode 30a and a second electrode 40a, disposed opposite on the two terminals of the substrate 10. The first electrode 30a has a first extending part 30b, and the second electrode 40a has a second extending part 40b. The first extending part 30b is connected to the voltage variable material 20 in a direction toward the second electrode 40a along the top surface S1 of the substrate 10 (i.e., along the x-axis), and the second extending part 40b is connected to the voltage variable material 20 in a direction toward the first electrode 30a along the top surface S1 of the substrate 10 (i.e., along the x-axis). In this way, the first electrode 30a and the second electrode 40a are connected to the two terminals of the voltage variable material 20 through the first extending part 30b and the second extending part 40b, respectively. The voltage variable material 20 has high electrical resistance and is not electrically conductive under normal conditions. When an event of ESD occurs, the high voltage of ESD causes the voltage variable material 20 to experience electrical breakdown and become electrically conductive, thereby mitigating the high voltage stress. The high voltage is reduced to a low voltage. The voltage required to cause the voltage variable material 20 to experience electrical breakdown (i.e., breakdown voltage) can be referred to as the “trip voltage” of the over-voltage protection device 100.

In addition, the voltage variable material 20 of the present invention includes an insulated metal material, a perovskite-based compound, and a silicone-containing resin.

The insulated metal material consists of a plurality of core metal particles, and each core metal particle is enclosed by an insulating layer. The plurality of core metal particles include iron, gold, silver, copper, nickel, tin, platinum, zinc, metal carbide, or combinations thereof. The insulating layer includes iron oxide, zirconium dioxide, aluminum oxide, hafnium dioxide, titanium dioxide, manganese oxide, or silicon dioxide. Simply put, the insulated metal material consists of electrically conductive particles that have undergone an insulating treatment. For instance, during a coating process, iron particles can be coated with an insulating material, thereby forming iron powder with high surface resistance. This design allows the voltage variable material 20 to have a quick response time (or trip time) of less than 1 nanosecond (ns), meeting the requirements for the input signal terminal of an electronic apparatus. In one embodiment, the total volume of the voltage variable material 20 is taken as 100%, and the insulated metal material accounts for 42% to 46.5%, such as 42%, 42.5%, 43%, 43.5%, 44%, 44.5%, 45%, 45.5%, or 46%. If the insulated metal material accounts for less than 42%, it will result in a response time that is too long. If the insulated metal material accounts for more than 46.5%, electrical conduction might unexpectedly occur. A high proportion of the insulated metal material can lead to excessive compaction of it, thereby narrowing the distance between core metal particles and significantly increasing the likelihood of electrical conduction under normal conditions.

It is noted that a filler with a perovskite structure (referred to as a “perovskite-based compound” hereinafter) is included in the present invention. The perovskite-based compound is selected from the group consisting of calcium titanate, strontium titanate, barium titanate, and combinations thereof. The present invention observes that the voltage variable material 20 can withstand a higher voltage without burnout, provided the proportion of the perovskite-based compound is controlled within a specific range. For instance, in one embodiment, a voltage-endurance value of the over-voltage protection device 100 is at least 8 kV, ensuring that the over-voltage protection device 100 is not burnt out after being subjected to 8 kV for 1000 cycles. In another embodiment, a voltage-endurance value of the over-voltage protection device 100 is at least 30 kV, ensuring that the over-voltage protection device 100 is not burnt out after being subjected to 30 kV for 100 cycles. Each cycle involves applying a specific voltage for 10 seconds, followed by turning it off for 60 seconds (i.e., 10 seconds on; 60 seconds off). The total volume of the voltage variable material 20 is taken as 100%, and the perovskite-based compound accounts for 0.5% to 4.5%, such as 0.5%, 1%, 1.5%, 2%, 2.5%, 3%, 3.5%, or 4%. Moreover, the present invention unexpectedly finds that the issue of leakage current can be improved by selecting strontium titanate as the perovskite-based compound used in the device. In one embodiment, the perovskite-based compound is strontium titanate, by which a leakage current of the over-voltage protection device 100 is lower than 0.5 nA.

The over-voltage protection device 100 of the present invention is a polymeric ESD protection device (i.e., pESD protection device). The silicone-containing resin serves as a matrix in the voltage variable material 20, in which the insulated metal material and the perovskite-based compound as previously mentioned are uniformly dispersed. The silicone-containing resin may be selected from the group consisting of silicone rubber, polydimethylsiloxane, polyethylpropylsiloxane, polypropylbutylsiloxane, polydiphenylsiloxane, polymethylphenylsiloxane, and combinations thereof. In one embodiment, the total volume of the voltage variable material 20 is taken as 100%, and the silicone-containing resin accounts for 51% to 55%, such as 51%, 52%, 53%, 54%, or 55%.

Please refer to FIG. 2, which shows a cross-sectional view of the over-voltage protection device 100 along line AA depicted in FIG. 1b. The substrate 10 further includes a bottom surface S2. The top surface S1 is opposite to the bottom surface S2. The electrode set further includes a third electrode 30d and a fourth electrode 40d disposed on the two terminals of the bottom surface S2. In addition, the sidewalls on both sides of the substrate 10 are recessed (as shown in FIG. 1b, each featuring a half-round profile), thereby accommodating a first connecting member 30c and a second connecting member 40c. The first electrode 30a is electrically connected to the third electrode 30d through the first connecting member 30c, and the second electrode 40a is electrically connected to the fourth electrode 40d through the second connecting member 40c. As described above, the over-voltage protection device 100 includes the protection layer C, which covers the first extending part 30b, the voltage variable material 20, and the second extending part 40b, thereby preventing unnecessary electrical connections and protecting the voltage variable material 20 from the external environment. The protection layer C includes an epoxy resin, such as bisphenol A epoxy resin, bisphenol F epoxy resin, bisphenol S epoxy resin, or combinations thereof. Moreover, the protection layer C has a glass transition temperature (Tg) higher than 140° C., preferably ranging from 150° C. to 165° C. Furthermore, the protection layer C has a coefficient of thermal expansion (CTE) α1 ranging from 25 ppm/° C. to 35 ppm/° C., and has a CTE α2 ranging from 135 ppm/° C. to 145 ppm/° C. “CTE α1” is defined as the CTE of an object at a temperature below Tg, while “CTE α2” is defined as the CTE of the object at a temperature above Tg.

Please refer to FIG. 3 and FIG. 4, which show an enlarged view and another embodiment, respectively, of the region enclosed by the dashed line of the over-voltage protection device 100 in FIG. 2. The present invention finds that in the presence of the recess R, the voltage variable material 20 must maintain a specific cross-sectional area to ensure its high voltage endurance performance. More specifically, in FIG. 3, the voltage variable material 20 has a width W parallel to the top surface S1 and a height H perpendicular to the top surface S1. The width W ranges from 36 μm to 48 μm, and the height H ranges from 55 μm to 65 μm. In addition, in order to increase the contact area of the voltage variable material 20, the voltage variable material 20 may attach to and extend along the substrate 10 by a certain distance. For instance, in FIG. 4, the voltage variable material 20 attaches to the top surface S1 and extends by a distance L. Therefore, the width of the voltage variable material 20 inside the recess R is smaller than the width of the voltage variable material 20 outside the recess R, forming a cross-sectional profile with a wider top and a narrower bottom.

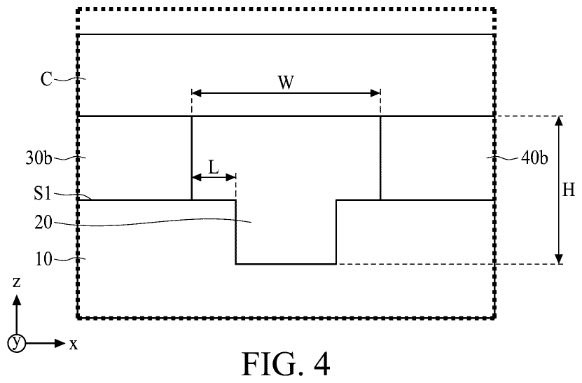

To describe the present invention more clearly, the following verification is provided, as shown in FIG. 1 to FIG. 5. The tests focused on the voltage variable material and the protection layer.

TABLE 1
Composition of Voltage Variable Material (vol %).

| | Insulated iron | Silicone | | | | | | |
|---|---|---|---|---|---|---|---|---|
| Group | powder | rubber | SrTiO₃ | BaTiO₃ | CaTiO₃ | AlN | ZnO | Al₂O₃ |
| E1 | 42.0 | 54.0 | 4.0 | | | | | |
| E2 | 43.5 | 54.0 | 2.5 | | | | | |
| E3 | 45.0 | 53.0 | 2.0 | | | | | |
| E4 | 44.5 | 54.0 | 1.5 | | | | | |
| E5 | 44.0 | 55.0 | 1.0 | | | | | |
| E6 | 46.5 | 51.0 | | 2.5 | | | | |
| E7 | 46.5 | 51.0 | | | 2.5 | | | |
| C1 | 46.5 | 51.0 | | | | 2.5 | | |
| C2 | 46.5 | 51.0 | | | | | | 2.5 |
| C3 | 48.0 | 51.0 | | | | | 1 | |
| C4 | 48.0 | 51.0 | | | | | 1 | |

Table 1 shows the composition of the voltage variable material for each embodiment (E1 to E7) and comparative example (C1 to C4) in terms of volume percentage. The first column shows the groups, that is, E1 to C4. The first row shows the materials available for the voltage variable material, including the insulated iron powder, silicone rubber, strontium titanate (SrTiO₃), barium titanate (BaTiO₃), calcium titanate (CaTiO₃), aluminum nitride (AlN), zinc oxide (ZnO), and aluminum oxide (Al₂O₃). The insulated iron powder corresponds to the insulated metal material as previously mentioned. To ensure optimal compaction of the insulated iron powder in the recess R, the diameter of each iron particle of the insulated iron powder is less than 10 μm. As shown in Table 1, the voltage variable material consists of an insulated conductor (i.e., insulated iron powder), a polymer (i.e., silicone rubber), and a filler (i.e., SrTiO₃, BaTiO₃, CaTiO₃, AlN, ZnO, or Al₂O₃). The difference between the embodiments and the comparative examples lies in the types of filler used. The embodiments E1 to E7 select the perovskite-based compounds as their fillers, while the comparative examples C1 to C4 select the conventional fillers. It is noted that the present invention unexpectedly found that a slight change in the proportion of strontium titanate (SrTiO₃) can significantly improve the device's electrical performance. Therefore, the embodiments E1 to E5 contain different ratios of strontium titanate (SrTiO₃) for the following tests.

Particle size (i.e., diameter) distribution of any filler of the present invention is under control and in a specific range. Before being formulated to the composition as shown in Table 1, particle size distribution of each filler is measured by the particle size analyzer (commercialized brand name Malvern Mastersizer 2000). The details are shown in Table 2 below.

TABLE 2
Particle Size Distribution of Filler.

| Filler | D(0.1) | D(0.5) | D(0.9) |
|---|---|---|---|
| BaTiO₃ | 0.97 μm | 8.29 μm | 19.3 μm |
| SrTiO₃ | 0.59 μm | 5.96 μm | 21.8 μm |
| CaTiO₃ | 0.95 μm | 9.15 μm | 27.3 μm |
| AlN | 1.01 μm | 4.28 μm | 9.63 μm |
| Al₂O₃ | 1.29 μm | 5.14 μm | 11.44 μm |

As shown in Table 2, “D” stands for “Distribution of particle size”, and the number within brackets after “D” refers to the proportion of the particles. The total number of particles is calculated as 1, so 0.1, 0.5 and 0.9 refer to 10%, 50% and 90%, respectively. Specifically, D(0.1), D(0.5), and D(0.9) represent particle sizes. For example, D(0.1) means that 10% of particles are smaller than the values of D(0.1) listed in Table 2. D(0.5) and D(0.9) are interpreted in the same way. Accordingly, D(0.5) stands for the middle value of particle size distribution, that is, the median diameter. In other words, in BaTiO₃, half the filler particles are smaller than 8.29 μm. In SrTiO₃, half the filler particles are smaller than 5.96 μm. In CaTiO₃, half the filler particles are smaller than 9.15 μm. It is noted that during the manufacturing process of the voltage variable material, the filler could be ground to less than 10 μm using a three-roll mill, for the sake of uniform dispersion within the voltage variable material. Therefore, a filler selected for blending is conventionally chosen with a diameter D(0.9) close to 10 μm to ensure that all particles of the filler are ground to less than 10 μm. However, the present invention selects the perovskite-based compounds with their diameters D(0.9) close to 20 μm. Although being processed through the three-roll mill, some particles may not be fully ground and remain larger (i.e., with diameters ranging from 10 μm to 20 μm). These larger particles may further enhance the overall voltage endurance of the voltage variable material.

TABLE 3
Protection layer.

| | | Glass transition | | |
|---|---|---|---|---|
| Protection | Viscosity | temperature | CTE α1 | CTE α2 |
| layer | (ps) | (° C.) | (ppm/° C.) | (ppm/° C.) |
| EI-4500 | 450 ± 40 | 160 | 30 | 140 |
| S-300 | 300 ± 100 | 124 | 25 | 175.4 |
| R-500 | 190 ± 30 | 144 | 19.2 | 159.4 |

In the embodiments and the comparative examples, each over-voltage protection device is covered by a protection layer as shown in FIG. 1b, after being produced in the structure in FIG. 1a. The protection layer is made of epoxy resin, with three types available for use. EI-4500 refers to the epoxy resin from the EPORITE series by EPOLAB Chemical Industries Inc., while S-300 and R-500 refer to the epoxy resins from the S-300 series and R-500 series by Onstatic Technology Co. Ltd. Compared with S-300 and R-500, EI-4500 has a higher viscosity and glass transition temperature (Tg), making its structure more stable at high temperatures. In addition, EI-4500 has the highest CTE α1 and the lowest CTE α2, which mean that EI-4500 has the highest CTE at temperatures below its Tg and the lowest CTE at temperatures above its Tg. The embodiments E1 to E7 use epoxy resin EI-4500 as the protective layer. The comparative examples C1 to C3 use epoxy resin S-300 as the protective layer, while the comparative example C4 uses epoxy resin R-500 as the protective layer.

The voltage variable materials of the embodiments and the comparative examples are produced using the same manufacturing process. First, the insulated iron powder, silicone rubber, and filler are blended for one hour to form a slurry. Next, the slurry is processed through the three-roll mill three times, and then measured using a particle size analyzer to verify whether the particle size is less than 10 μm. The processed slurry is printed into the recess R, followed by a curing process at 170° C. to form a voltage variable material. The voltage variable material is then covered by a protection layer, followed by a curing process at 170° C. Finally, the device is subjected to irradiation of 100 kGy.

TABLE 4
Electrical Characteristic 1.

| | | Voltage | Voltage | Voltage |
|---|---|---|---|---|
| | Trip voltage | endurance | endurance | endurance |
| Group | (V) | test 1 | test 2 | test 3 |
| E1 | 467 | Pass | Pass | Pass |
| E2 | 459 | Pass | Pass | Pass |
| E3 | 421 | Pass | Pass | Pass |
| E4 | 433 | Pass | Pass | Pass |
| E5 | 441 | Pass | Pass | Pass |
| E6 | 449 | Pass | Pass | Pass |
| E7 | 423 | Pass | Pass | Pass |
| C1 | 368 | Pass | Fail | Fail |
| C2 | 390 | Pass | Fail | Fail |
| C3 | 624 | Pass | Fail | Fail |
| C4 | 639 | Pass | Fail | Fail |

In Table 4, the trip voltage and voltage endurance capability of each group are shown above.

The trip voltage is defined in the context above, and is not described in detail herein.

In the voltage endurance tests, each cycle involves applying a specific voltage for 10 seconds, followed by turning it off for 60 seconds (i.e., 10 seconds on; 60 seconds off).

In the voltage endurance test 1, the applied voltage is 8 kV for 1000 cycles.

In the voltage endurance test 2, the applied voltage is 30 kV for 50 cycles.

In the voltage endurance test 3, the applied voltage is 30 kV for 100 cycles.

In the embodiments E1 to E7, the trip voltages are stable, ranging from 400 V to 500 V. In contrast, the trip voltages of the comparative examples C to C4 are relatively volatile, ranging from 300 V to 700 V. Moreover, after tripping, the devices in the embodiments E1 to E7 can withstand the high voltage (i.e., 30 kV as previously mentioned) without burnout. However, the devices in the comparative examples C1 to C4 can only pass the voltage endurance test 1 and cannot pass the voltage endurance tests 2 and 3 without burnout. Clearly, the structural design and composition of the present invention allow the over-voltage protection device to withstand a higher voltage.

TABLE 5
Electrical Characteristic 2.

| | Leakage current | Leakage current | Leakage current |
|---|---|---|---|
| | during trip event | in voltage | in voltage |
| | by low voltage | endurance test 2 | endurance test 3 |
| Group | (nA) | (nA) | (nA) |
| E1 | 0.73 | 0.08 | 0.2 |
| E2 | 0.25 | 0.04 | 0.5 |
| E3 | 0.015 | 0.015 | 0.09 |
| E4 | 0.015 | 0.025 | 0.1 |
| E5 | 0.014 | 0.03 | 0.09 |
| E6 | 7.6 | 10 | 650 |
| E7 | 10 | 8.5 | 365 |
| C1 | 3.55 | — | — |
| C2 | 136 | — | — |
| C3 | 257 | — | — |
| C4 | 0.007 | — | — |

The leakage current of each group is further shown in Table 5.

“Leakage current during trip event by low voltage” refers to the maximum leakage current of an over-voltage protection device after being subjected to a voltage of 2 kV for 50 cycles. “Leakage current in voltage endurance test 2” refers to the maximum voltage leakage current of an over-voltage protection device after undergoing the voltage endurance test 2 as previously mentioned. “Leakage current in voltage endurance test 3” refers to the maximum voltage leakage current of an over-voltage protection device after undergoing the voltage endurance test 3 as previously mentioned. As shown in Table 5, although all the embodiments and comparative examples are not burnt out at a relatively low voltage, the leakage currents of the comparative examples are generally higher, with one even reaching up to 257 nA. It is noted that the leakage currents of the embodiments E1 to E5 are less than 1 nA, significantly lower than those of the embodiments E6 and E7. This difference becomes quite evident as the applied voltage increases. For instance, the leakage currents of the embodiments E1 to E5 range from 0.09 nA to 0.5 nA after the voltage endurance test 3, while the leakage currents of the embodiments E6 and E7 range from 365 nA to 650 nA, which is hundreds to thousands of times higher. As previously mentioned, the perovskite-based compound used in the embodiments E1 to E5 is strontium titanate (SrTiO₃), while the perovskite-based compounds used in the embodiments E6 and E7 are barium titanate (BaTiO₃) and calcium titanate (CaTiO₃), respectively. Accordingly, the present invention not only enhances the voltage endurance and durability of the over-voltage protection device through the perovskite-based compounds, but also discovers that a specific perovskite-based compound (i.e., SrTiO₃) can further improve the issue of leakage current.

The above-described embodiments of the present invention are intended to be illustrative only. Numerous alternative embodiments may be devised by persons skilled in the art without departing from the scope of the following claims.

What is claimed is:

1. An over-voltage protection device, comprising:
a substrate having a surface and a recess formed on the surface;
a voltage variable material disposed in the recess and comprising an insulated metal material, a perovskite-based compound, and a silicone-containing resin, wherein:
the perovskite-based compound is selected from the group consisting of calcium titanate, strontium titanate, barium titanate, and combinations thereof; and
the total volume of the voltage variable material is taken as 100%, and the perovskite-based compound accounts for 0.5% to 4.5%; and
an electrode set comprising a first electrode and a second electrode respectively connected to two terminals of the voltage variable material.

2. The over-voltage protection device of claim 1, wherein the perovskite-based compound is strontium titanate accounting for 1% to 4% by volume.

3. The over-voltage protection device of claim 2, wherein the total volume of the voltage variable material is taken as 100%, and the silicone-containing resin accounts for 51% to 55%.

4. The over-voltage protection device of claim 3, wherein the silicone-containing resin is selected from the group consisting of silicone rubber, polydimethylsiloxane, polyethylpropylsiloxane, polypropylbutylsiloxane, polydiphenylsiloxane, polymethylphenylsiloxane, and combinations thereof.

5. The over-voltage protection device of claim 3, wherein:
the total volume of the voltage variable material is taken as 100%, and the insulated metal material accounts for 42% to 46.5%; and
the insulated metal material consists of a plurality of core metal particles, and each core metal particle is enclosed by an insulating layer.

6. The over-voltage protection device of claim 5, wherein the insulated metal material has a particle diameter ranging from 0.1 μm to 10 μm.

7. The over-voltage protection device of claim 6, wherein the plurality of core metal particles comprise iron, gold, silver, copper, nickel, tin, platinum, zinc, metal carbide, or combinations thereof.

8. The over-voltage protection device of claim 7, wherein the insulating layer comprises iron oxide, zirconium dioxide, aluminum oxide, hafnium dioxide, titanium dioxide, manganese oxide, or silicon dioxide.

9. The over-voltage protection device of claim 1, wherein the voltage variable material has a width parallel to the surface and a height perpendicular to the surface, wherein the width ranges from 36 μm to 48 μm, and the height ranges from 55 μm to 65 μm.

10. The over-voltage protection device of claim 1, wherein the voltage variable material attaches to the surface and extends by a distance, whereby a width of the voltage variable material inside the recess is smaller than a width of the voltage variable material outside the recess.

11. The over-voltage protection device of claim 1, wherein the first electrode has a first extending part and the second electrode has a second extending part, wherein the first extending part is connected to the voltage variable material in a direction toward the second electrode along the surface of the substrate, and the second extending part is connected to the voltage variable material in a direction toward the first electrode along the surface of the substrate.

12. The over-voltage protection device of claim 11, further comprising a protection layer, wherein the protection layer covers the first extending part, the voltage variable material, and the second extending part.

13. The over-voltage protection device of claim 12, wherein the protection layer comprises bisphenol A epoxy resin, bisphenol F epoxy resin, bisphenol S epoxy resin, or combinations thereof.

14. The over-voltage protection device of claim 13, wherein the protection layer has a glass transition temperature higher than 140° C.

15. The over-voltage protection device of claim 14, wherein the glass transition temperature of the protection layer ranges from 150° C. to 165° C.

16. The over-voltage protection device of claim 15, wherein the protection layer has a coefficient of thermal expansion (CTE) α1 ranging from 25 ppm/° C. to 35 ppm/° C., and has a CTE α2 ranging from 135 ppm/° C. to 145 ppm/° C.

17. The over-voltage protection device of claim 1, wherein a voltage-endurance value of the over-voltage protection device is at least 8 kV, whereby the over-voltage protection device is not burnt out after being subjected to 8 kV for 1000 cycles.

18. The over-voltage protection device of claim 1, wherein a voltage-endurance value of the over-voltage protection device is at least 30 kV, whereby the over-voltage protection device is not burnt out after being subjected to 30 kV for 100 cycles.

19. The over-voltage protection device of claim 1, wherein a leakage current of the over-voltage protection device is lower than 0.5 nA.
